(19) United States
(12) Patent Application Publication
(10) Pub. No.: US 2013/0326371 A1
(43) Pub. Date: Dec. 5, 2013

(54) Methods And Apparatuses For Sharing Information

(71) Applicant: BEIJING XIAOMI Technology CO., LTD, Beijing (CN)

(72) Inventor: Ruijun Xu, Beijing (CN)

(73) Assignee: BEIJING XIAOMI Technology CO., LTD, Beijing (CN)

(21) Appl. No.: 13/903,534

(22) Filed: May 28, 2013

(30) Foreign Application Priority Data
May 29, 2012 (CN) CN201210171873.X

(51) Int. Cl. H04L 29/08; G06F 3/0482

(52) U.S. Cl. CPC H04L 67/10; G06F 3/0482
USPC 715/753; 709/204

(57) ABSTRACT

A method for sharing information for use in a first terminal, including: receiving, through an information display interface of the first terminal, a copy instruction for copying selected information; and transmitting, in response to the receiving of the copy instruction, the information to a server.

### RELATED APPLICATIONS

This application is based upon and claims the benefit of priority, from Chinese Patent Application No. CN201210171873.X, filed May 29, 2012, the entire contents of which are incorporated herein by reference.

### TECHNICAL FIELD

The disclosure generally relates to communication technology, and more particularly, to methods and apparatuses for sharing information.

### BACKGROUND

With development and popularization of technology, mobile communication has become one of the most important means of communication. Mobile terminals play a more and more important role in people's life.

Communication between mobile terminals, however, may lack an efficient means of sharing information. For example, there are generally two traditional methods for sharing information between a first terminal and a second terminal, wherein the first terminal sends information and the second terminal receives information.

In the first traditional method, sharing information between the first terminal and the second terminal is based on traditional text editing software, such as WORD or PDF. For example, an information sharing process on the side of the first terminal may include using a text editing file of a certain type, such as a WORD file or a PDF file, to include information to be shared, and then transmitting the file t the second terminal.

In the second traditional method, sharing information between the first terminal and the second terminal is based on traditional instant message software. For example, an information sharing process on the side of the first terminal may include inputting information to be shared in a dialog box of the instant message software, and transmitting the information to a dialog box of the instant message software on the second terminal.

### SUMMARY

According to a first aspect of the present disclosure, there is provided a method for sharing information for use in a first terminal, comprising: receiving, through an information display interface of the first terminal, a copy instruction for copying selected information; and transmitting, in response to the receiving of the copy instruction, the information to a server.

According to a second aspect of the present disclosure, there is provided a method for sharing information for use in a second terminal, comprising: receiving a paste instruction for pasting information copied at a first terminal and stored in a server; acquiring, in response to the receiving of the paste instruction, the information from the server; and pasting the acquired information in an information display interface of the second terminal.

According to a third aspect of the present disclosure, there is provided a method for sharing information for use in a server, comprising: receiving information transmitted by a first terminal; storing the received information; and sending the stored information to a second terminal in response to a request by the second terminal to acquire the information.

According to a fourth aspect of the present disclosure, there is provided an apparatus for sharing information and for use in a first terminal, comprising: a receiving unit configured to receive, through an information display interface of the first terminal, a copy instruction for copying selected information; and a transmitting unit configured to transmit, in response to the receiving unit receiving the copy instruction, the information to a server.

According to a fifth aspect of the present disclosure, there is provided an apparatus for sharing information and for use in a second terminal, comprising: a receiving unit configured to receive a paste instruction for pasting information copied at a first terminal and stored in a server; an acquiring unit configured to acquire, in response to the first receiving unit receiving the paste instruction, the information from the server; and a pasting unit configured to paste the information in an information display interface of the second terminal.

According to a sixth aspect of the present disclosure, there is provided an apparatus for sharing information and for use in a server, comprising: a receiving unit configured to receive information transmitted by a first terminal; a storing unit configured to store the received information by the server; and a sending unit configured to send the stored information to a second terminal in response to a request by the second terminal to acquire the information.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 illustrates a block diagram of a system for sharing information, according to an exemplary embodiment.

FIG. 2 illustrates a diagram of an information display interface of a first terminal, according to an exemplary embodiment.

FIG. 3 illustrates a diagram of an information display interface of a first terminal, according to an exemplary embodiment.

FIG. 4 illustrates a diagram of an information display interface of a second terminal, according to an exemplary embodiment.

FIG. 5 illustrates a diagram of an information display interface of a second terminal, according to an exemplary embodiment.

FIG. 6 illustrates a flowchart of a method for sharing information, according to an exemplary embodiment.

FIG. 7 illustrates a flowchart of a method for sharing information, according to an exemplary embodiment.

FIG. 8 illustrates a flowchart of a method for sharing information, according to an exemplary embodiment.

FIG. 9 illustrates a flowchart of a method for sharing information, according to an exemplary embodiment.

FIG. 10 illustrates a diagram of a flowing window, according to an exemplary embodiment.

FIG. 11 illustrates a flowchart of a method for sharing information, according to an exemplary embodiment.

FIG. 12 illustrates a block diagram of an apparatus for sharing information, according to an exemplary embodiment.

FIG. 13 illustrates a block diagram of an apparatus for sharing information, according to an exemplary embodiment.

FIG. 14 illustrates a block diagram of an apparatus for sharing information, according to an exemplary embodiment.

FIG. 15 illustrates a block diagram of an apparatus for sharing information, according to an exemplary embodiment.

FIG. 16 illustrates a block diagram of an apparatus for sharing information, according to an exemplary embodiment.

### DETAILED DESCRIPTION OF EXEMPLARY EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

In exemplary embodiments disclosed herein, the term “first terminal” refers to a terminal for sending information, and the term “second terminal” refers to a terminal for receiving the information sent by the first terminal. Further, a first terminal and a second terminal may each be a personal computer, a mobile phone, or a user terminal with a touch-sensitive display, etc.

In exemplary embodiments disclosed herein, the term “information display interface” refers to an interface for displaying information. In one exemplary embodiment, information display interface is a text editing interface, when information to be shared is text, such as a text box of a note, or a text box of a message, or a WORD document interface. In another exemplary embodiment, information display interface is an interface after a file folder is opened, when information to be shared is a text file, a multimedia file, or an image file.

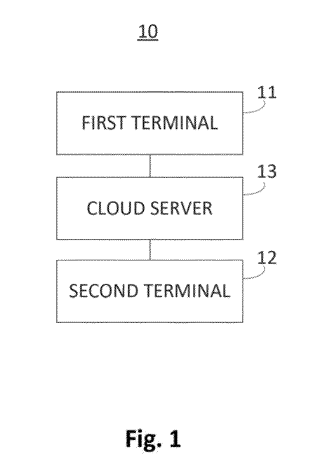

FIG. 1 illustrates a block diagram of a system 10 for sharing information, according to an exemplary embodiment. Referring to FIG. 1, the system 10 for sharing information includes a first terminal 11, a second terminal 12, and a server such as a cloud server 13. For example, one or more devices, such as computers, may be programmed to coordinate to operate as the cloud server 13. The first terminal 11 and the second terminal 12 are each configured to wirelessly communicate with the cloud server 13.

In exemplary embodiments, each of the first terminal 11, the second terminal 12, and the cloud server 13 may include one or more of the following components: a processor configured to execute computer program instructions to perform various processes and methods, random access memory (RAM) and read only memory (ROM) configured to access and store information and computer program instructions, storage to store data and information, databases to store tables, lists, or other data structures, I/O devices, interfaces, antennas, etc.

In exemplary embodiments, the first terminal 11 receives a copy instruction from a user for copying selected information through an information display interface, and transmits, in response to receiving the copy instruction, the information to the cloud server 13, which operates as a clipboard and stores the information.

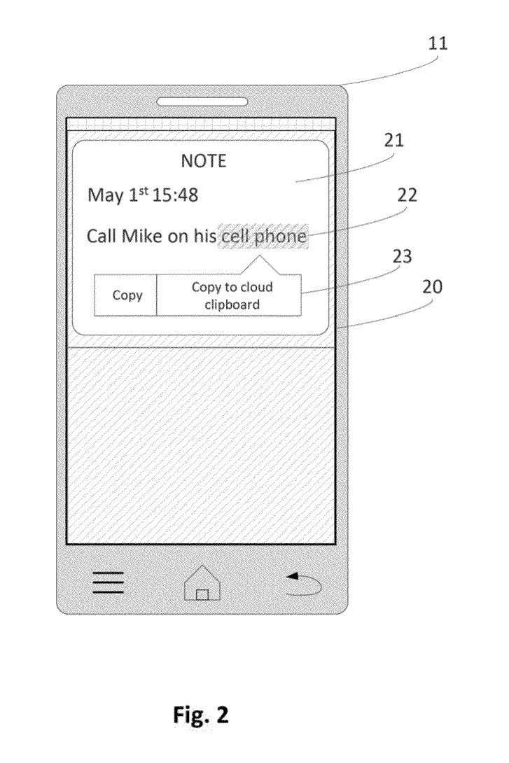

FIG. 2 illustrates a diagram of the information display interface of the first terminal 11 (FIG. 1), according to an exemplary embodiment. Referring to FIGS. 1 and 2, the information display interface may be a text box 21 of a note displayed on a display 20 of the first terminal 11. If a specified operation is executed by the user in the text box 21, the first terminal 11 may display a menu for receiving the copy instruction from the user. For example, assuming the display 20 of the first terminal 11 is a touch-sensitive display, if the user clicks the text box 21 for a predetermined period of time and then slides over the text to be selected, a piece of text 22 in the text box 21 will be selected and a menu 23 including an option of, e.g., “copy to cloud clipboard,” will be displayed. Alternatively, if the piece of text 22 in the text box 21 is selected through other ways and the user then presses a specified button (not shown) of the first terminal 11, the menu 23 will be displayed. The specified button may be a soft button shown on the touch-sensitive display or a physical button. When the option of “copy to cloud clipboard” is selected by the user, the first terminal 11 receives the copy instruction.

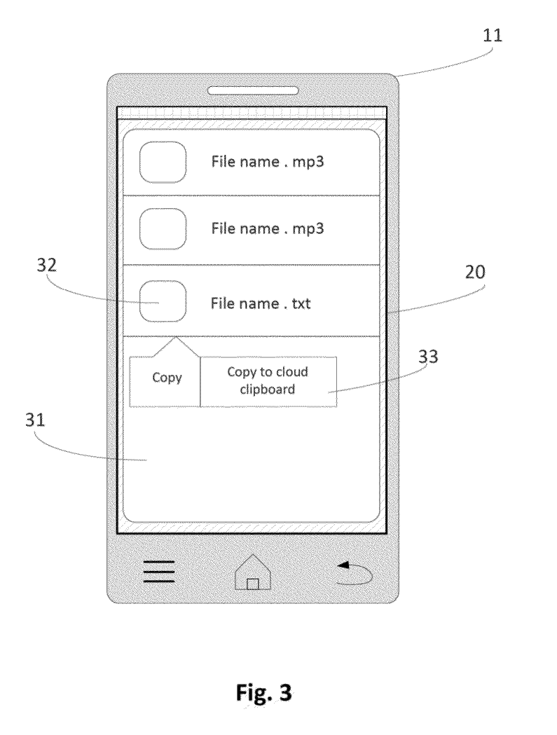

FIG. 3 illustrates a diagram of the information display interface of the first terminal 11 (FIG. 1), according to an exemplary embodiment. Referring to FIGS. 1 and 3, the information display interface may be an interface 31 displayed on the display 20 after a file folder is opened on the first terminal 11. If a specified operation is executed by the user in the interface 31, the first terminal 11 may display a menu for receiving the copy instruction from the user. For example, if the user clicks on a text file 32 for a predetermined period of time, the text file 32 will be selected and a menu 33 including an option of, e.g., “copy to cloud clipboard,” will be displayed. Alternatively, if the text file 32 is selected through other ways and the user then presses a specified button (not shown) of the first terminal 11, the menu 33 will be displayed. The specified button may be a soft button or a physical button. When the option of “copy to cloud clipboard” is selected by the user, the first terminal 11 receives the copy instruction.

Referring back to FIG. 1, in exemplary embodiments, the second terminal 12 receives from a user a paste instruction for pasting information copied at the first terminal 11 and stored in the cloud server 13 as a clipboard, acquires the information from the cloud server 13, and pastes the acquired information in an information display interface of the second terminal 12.

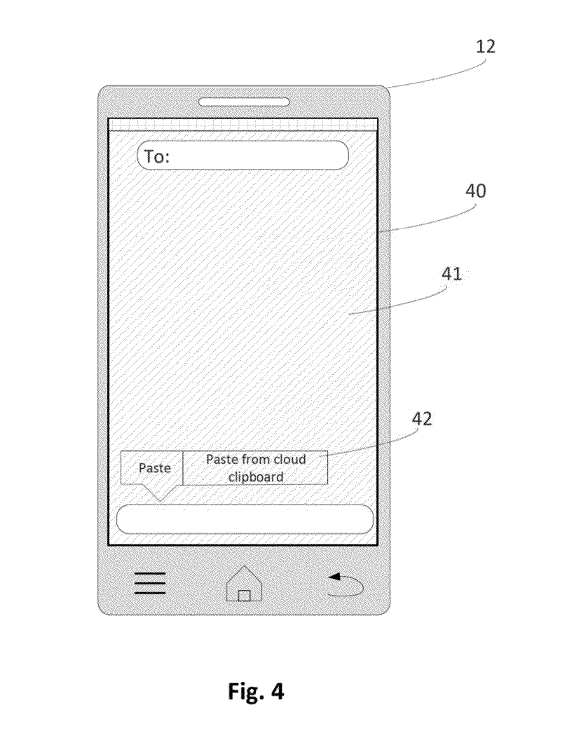

FIG. 4 illustrates a diagram of the information display interface of the second terminal 12 (FIG. 1), according to an exemplary embodiment. Referring to FIGS. 1 and 4, the information display interface may be a text box 41 of a message displayed on a display 40 of the second terminal 12. If a specified operation is executed by the user in the text box 41, the second terminal 12 will display a menu for receiving the paste instruction from the user. For example, assuming the display 40 of the second terminal 12 is a touch-sensitive display, if the user clicks the text box 41 for a predetermined period of time, a menu 42 including an option of, e.g., “paste from cloud clipboard,” will be displayed. Alternatively, if the user presses a specified button (not shown) of the second terminal 12, the menu 42 will be displayed. The specified button may be a soft button shown on the touch-sensitive display or a physical button. When the option of “paste from cloud clipboard” is selected by the user, the second terminal 12 receives the paste instruction.

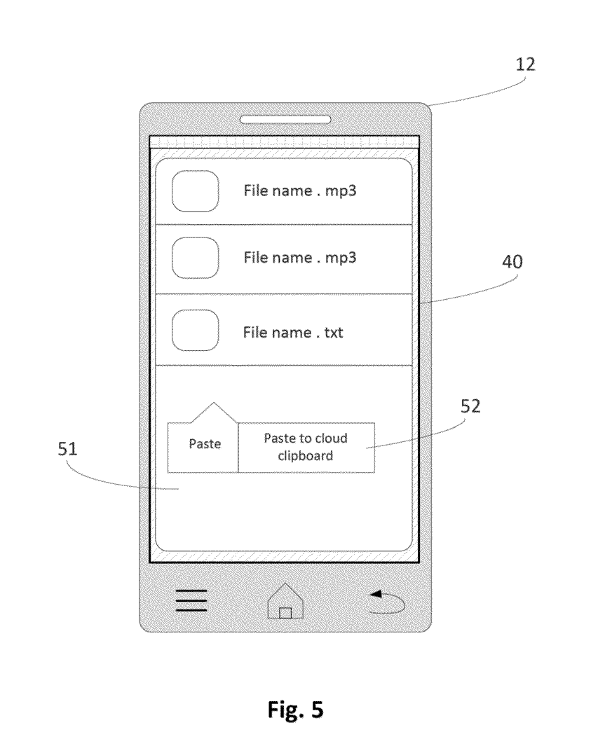

FIG. 5 illustrates a diagram of the information display interface of the second terminal 12 (FIG. 1), according to an exemplary embodiment. Referring to FIGS. 1 and 5, the information display interface may be an interface 51 displayed on the display 40 after a file folder is opened on the second terminal 12. If a specified operation is executed by the user in the interface 51, the second terminal 12 will display a menu for receiving the paste instruction from the user. For example, if the user clicks the interface 51 for a predetermined period of time, a menu 52 including an option of, e.g., “paste from cloud clipboard,” will be displayed. Alternatively, if the user presses a specified button (not shown) of the second terminal 12, the menu 52 will be displayed. The specified button may be a soft button or a physical button. When the option of “paste from cloud clipboard” is selected by the user, the second terminal 12 receives the paste instruction.

In exemplary embodiments, the second terminal 12 pastes the information in the information display interface, after acquiring the information from the cloud server 13.

Referring back to FIG. 1, in exemplary embodiments, the cloud server 13 operates as a clipboard of the first terminal 11 and the second terminal 12, as will be further described below. As a result, information can be shared between the first terminal 11 and the second terminal 12 without traditional text editing software or instant message software.

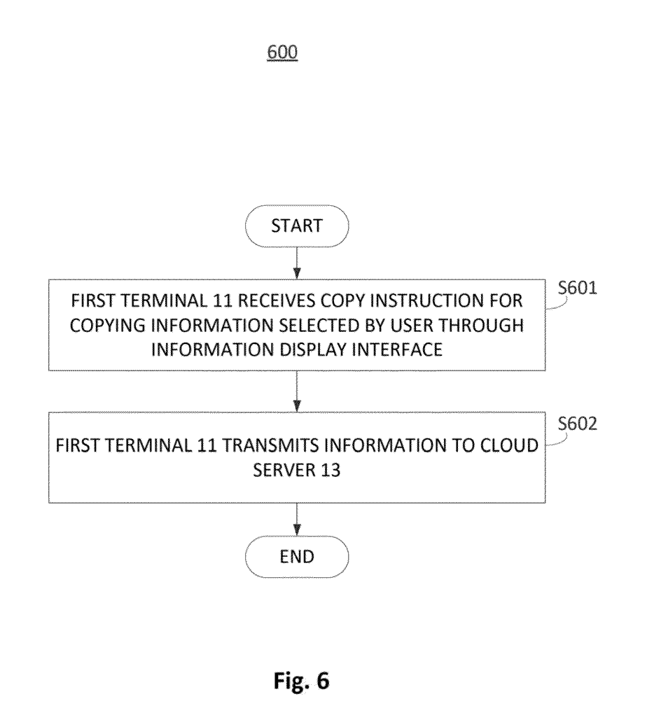

FIG. 6 illustrates a flowchart of a method 600 for sharing information between the first terminal 11 and the second terminal 12 (FIG. 1), according to an exemplary embodiment. Referring to FIGS. 1 and 6, the first terminal 11 receives a copy instruction from a user for copying selected information through an information display interface, such as that described above with respect to FIG. 2 or FIG. 3 (step S601). Then, in response to receiving the copy instruction, the first terminal 11 automatically transmits the information to the cloud server 13 (step S602).

In the illustrated exemplary embodiment, the first terminal 11 may display a menu with an option of, e.g., “copy to cloud clipboard,” to the user when a specified operation executed by the user is detected, and the option is used to receive the copy instruction from the user. For example, as described above with respect to FIG. 2, if the user clicks the text box 21 for a predetermined period of time and then slides over the text to be selected, the piece of text 22 in the text box 21 will be selected and the menu 23 including the option of “copy to cloud clipboard” will be displayed. When the option of “copy to cloud clipboard” is selected by the user, the first terminal 11 receives the copy instruction.

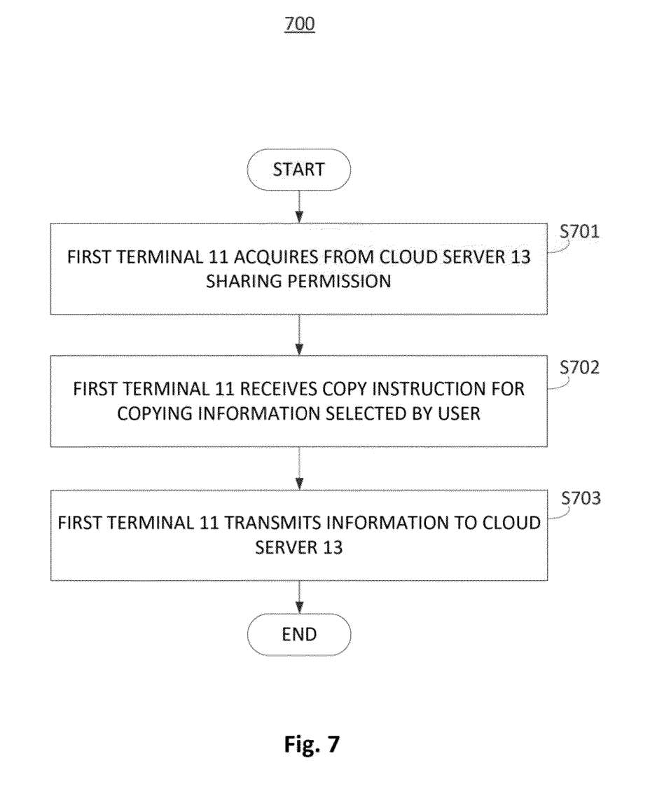

FIG. 7 illustrates a flowchart of a method 700 for sharing information between the first terminal 11 and the second terminal 12 (FIG. 1), according to an exemplary embodiment. Referring to FIGS. 1 and 7, the first terminal 11 acquires from the cloud server 13 a sharing permission (step S701). In one exemplary embodiment, a process for acquiring from the cloud server 13 the sharing permission executed by the first terminal 11 may include sending a sharing request to the cloud server 13, and receiving the sharing permission from the cloud server 13. For example, after receiving the sharing request from the first terminal 11, the cloud server 13 assigns a specified location in its storage to store information to be shared according to an account used by the first terminal 11 when establishing a connection with the cloud server 13. The cloud server 13 then sends the sharing permission to the first terminal 11. In another exemplary embodiment, the first terminal 11 does not send the sharing request. The cloud server 13 assigns a specified location in its storage to the account when the connection is established, and then sends the sharing permission to the first terminal 11.

Next, the first terminal 11 receives a copy instruction for copying information selected by the user through an information display interface (step S702). In response to receiving the copy instruction, the first terminal 11 automatically transmits the information to the cloud server 13 (step S703).

In the illustrated exemplary embodiment, the first terminal 11 may display a menu including an option of, e.g., “copy to cloud clipboard,” to the user when a specified operation executed by the user is detected, and the option is used to receive the copy instruction from the user. For example, as described above with respect to FIG. 2, if the piece of text 22 in the text box 21 is selected through certain ways and the user then presses the specified button, the menu 23 will be displayed. When the option of “copy to cloud clipboard” is selected by the user, the first terminal 11 receives the copy instruction. In addition, in the illustrated exemplary embodiment, the first terminal 11 activates the option of “copy to cloud clipboard” in the menu after acquiring the sharing permission. As a result, the user can provide the copy instruction for copying information by selecting the option.

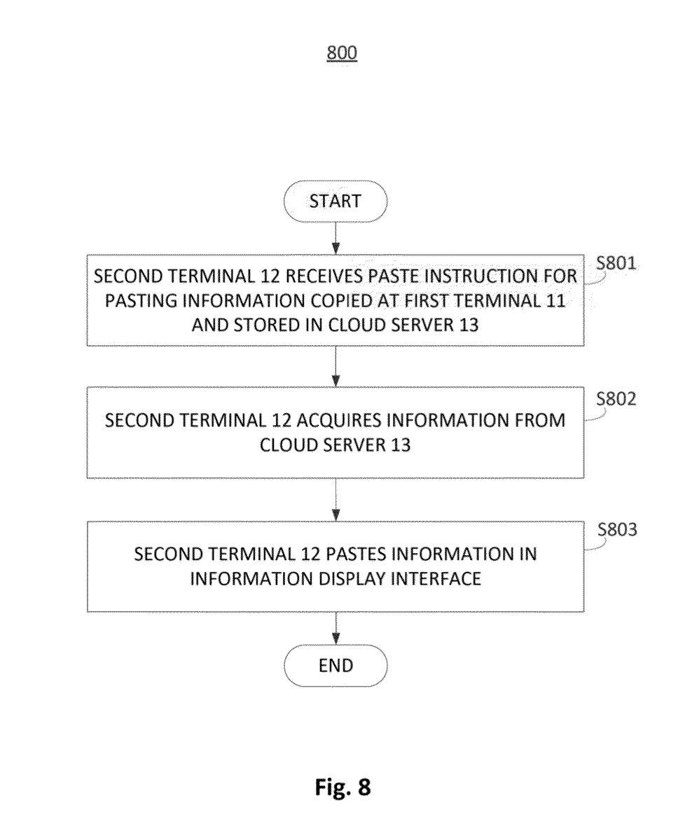

FIG. 8 illustrates a flowchart of a method 800 for sharing information between the first terminal 11 and the second terminal 12 (FIG. 1), according to an exemplary embodiment. Referring to FIGS. 1 and 8, the second terminal 12 receives a paste instruction from a user for pasting information copied at the first terminal 11 and stored in the cloud server 13 (step S801) and acquires the information from the cloud server 13 (step S802). After acquiring the information, the second terminal 12 pastes the information in an information display interface of the second terminal 12 (step S803).

In the illustrated exemplary embodiment, the second terminal 12 may display a menu including an option of, e.g., “paste from cloud clipboard,” to the user when a specified operation executed by the user is detected, and the option is used to receive the paste instruction from the user. For example, as described above with respect to FIG. 4, if the user clicks the text box 41 for a predetermined period of time, the menu 42 including the option of “paste from cloud clipboard” will be displayed. In addition, in the illustrated exemplary embodiment, the second terminal 12 may receive from the cloud server 13 a sharing reminder for reminding that the information can be pasted, and display the received sharing reminder to the user. When reading the reminder, the user may provide the paste instruction by selecting the option of “paste from cloud clipboard.”

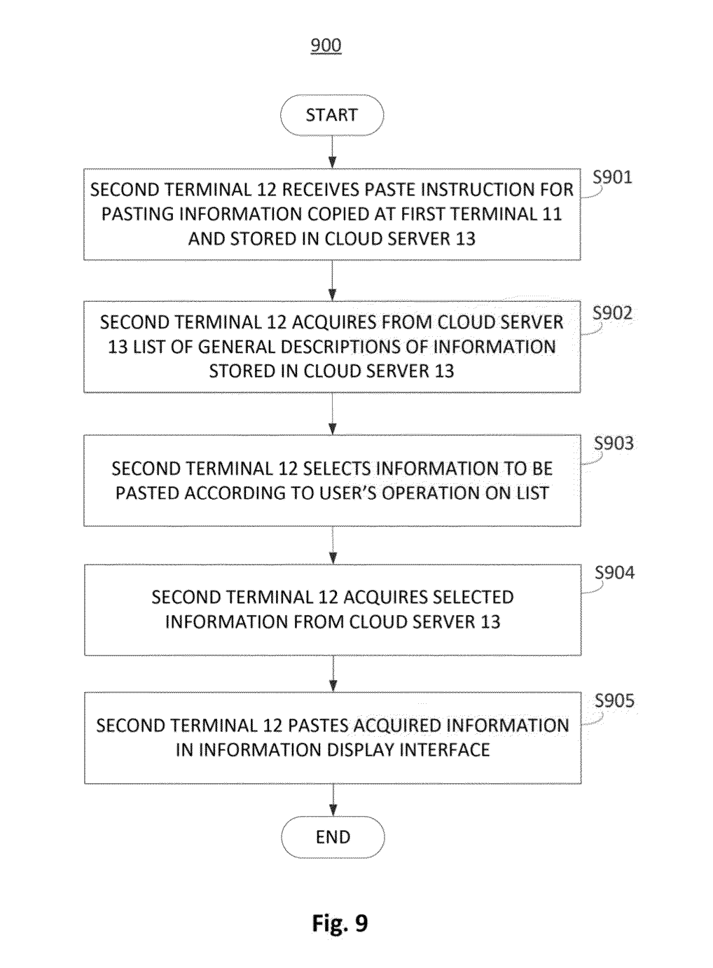

FIG. 9 illustrates a flowchart of a method 900 for sharing information between the first terminal 11 and the second terminal 12 (FIG. 1), according to an exemplary embodiment. Referring to FIGS. 1 and 9, the second terminal 12 receives a paste instruction from a user for pasting information copied at the first terminal 11 and stored in the cloud server 13 (step S901). Then the second terminal 12 acquires from the cloud server 13 a list of general descriptions of information stored in the cloud server 13 (step S902). The general descriptions may include quantity of information stored in the cloud server 13 and the first few words of each piece of information. The list can be displayed in a flowing window in the information display interface of the second terminal 12.

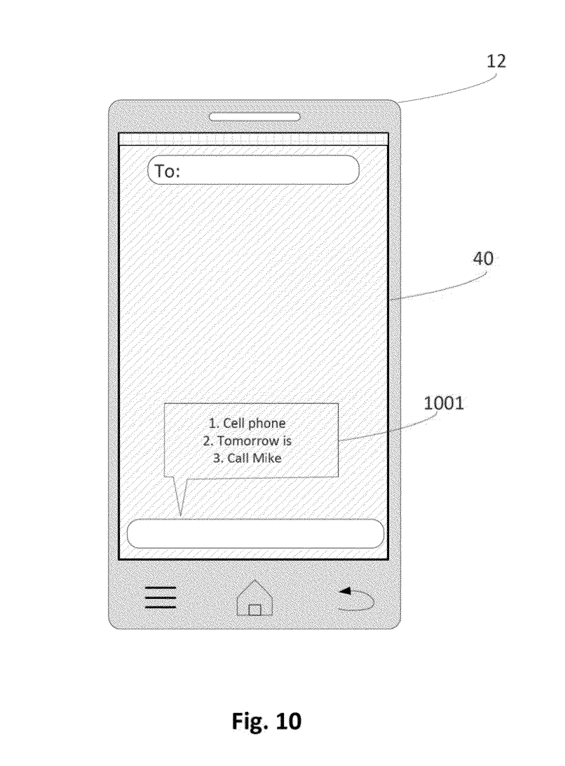

FIG. 10 illustrates a diagram of a flowing window 1001 displayed on the display 40 of the second terminal 12, according to an exemplary embodiment. Referring to FIG. 10, the list is displayed in the flowing window 1001. The user may select information to be pasted in the information display interface according to the list. For example, when the list shows the first few words of each piece of information, the user may select one piece of information by a clicking operation or select more pieces of information by a sliding operation.

Referring back to FIGS. 1 and 9, the second terminal 12 selects information to be pasted according to the user's operation on the list (step S903). After acquiring the selected information from the cloud server 13 (step S904), the second terminal 12 pastes the acquired information in the information display interface (step S905).

In the exemplary embodiment illustrated in FIGS. 9 and 10, the second terminal 12 may display a menu including an option of, e.g., “paste from cloud clipboard,” to the user when a specified operation executed by the user is detected, and the option is used to receive the paste instruction from the user. As described above with respect to FIG. 4, if the user presses the specified button, the menu 42 including the option of “paste from cloud clipboard” will be displayed. In addition, in the exemplary embodiment illustrated in FIGS. 9 and 10, the second terminal 12 may receive from the cloud server 13 a sharing reminder for reminding that the information can by pasted, and display the sharing reminder to the user. When reading the reminder, the user may provide the paste instruction by selecting the option of “paste from cloud clipboard.”

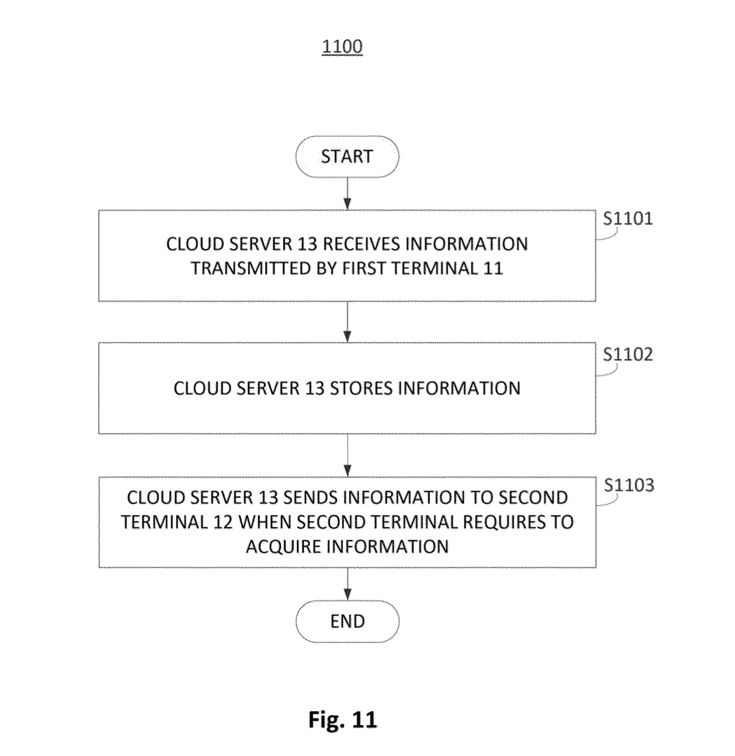

FIG. 11 illustrates a flowchart of a method 1100 for sharing information between the first terminal 11 and the second terminal 12 (FIG. 1), according to an exemplary embodiment. Referring to FIGS. 1 and 11, the cloud server 13 receives information transmitted by the first terminal 11 (step S1101), and stores the received information (step S1102). When the second terminal 12 requests to acquire the information, the cloud server 13 sends the information to the second terminal 12 (step S1103).

In the illustrated exemplary embodiment of FIG. 11, the cloud server 13 assigns a specified location in its storage to store the information according to an account used by the first terminal 11 and the second terminal 12 when establishing a connection with the cloud server 13. Accordingly, when the second terminal 12 requests to acquire the information, the cloud server 13 queries the specified location corresponding to the account used by the first terminal 11 and the second terminal 12. In addition, in the illustrated exemplary embodiment, the cloud server 13 may store the information transmitted by the first terminal 11 for a predetermined period of time. When the predetermined period of time is reached, the cloud server 13 may delete the stored information to save storage space.

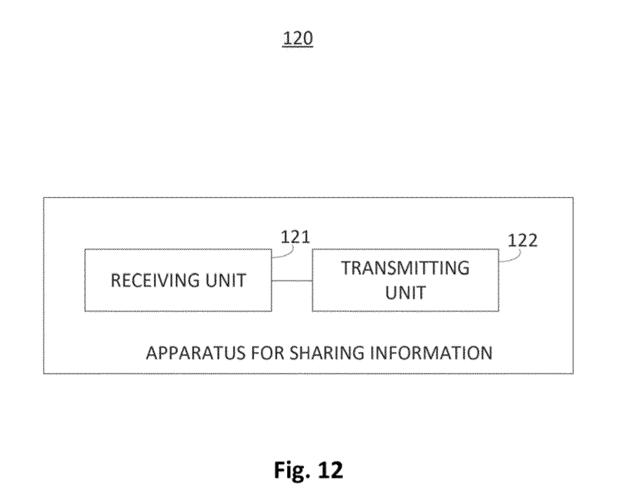

FIG. 12 is a block diagram of an apparatus 120 for sharing information, according to an exemplary embodiment. The apparatus 120 is configured to operate in accordance with the above described methods for sharing information. Referring to FIG. 12, the apparatus 120 for sharing information is included in the first terminal 11 (FIG. 1), and includes a receiving unit 121 and a transmitting unit 122.

Referring to FIGS. 1 and 12, in exemplary embodiments, the receiving unit 121 receives a copy instruction for copying information selected by the user through the information display interface of the first terminal 11. In response to the receiving unit 121 receiving the copy instruction, the transmitting unit 122 automatically transmits the information to the cloud server 13, which operates as a clipboard.

In the illustrated exemplary embodiment of FIG. 12, the apparatus 120 for sharing information may further include a displaying unit (not shown). The displaying unit displays on the display 20 of the first terminal 11 a menu including an option of, e.g., “copy to cloud clipboard,” to the user when a specified operation executed by the user is detected. The option is used to receive the copy instruction from the user.

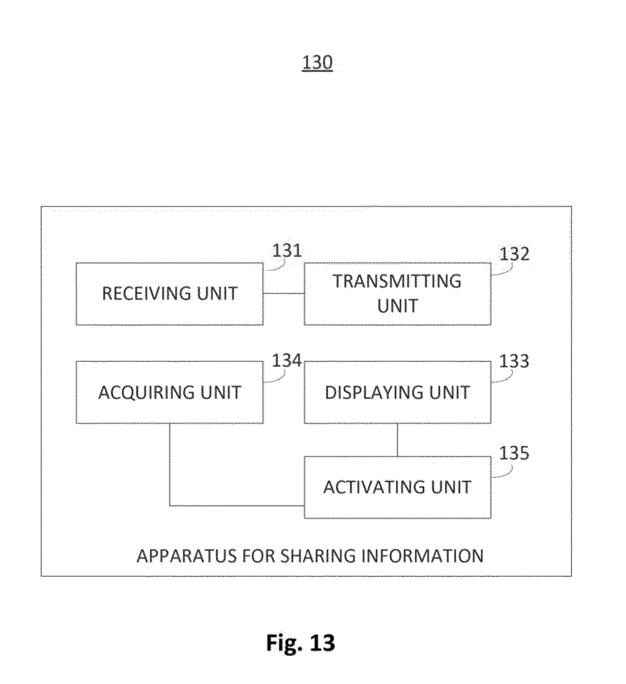

FIG. 13 illustrates a block diagram of an apparatus 130 for sharing information, according to an exemplary embodiment. The apparatus 130 is configured to operate in accordance with the above described methods for sharing information. Referring to FIG. 13, the apparatus 130 for sharing information is included in the first terminal 11 (FIG. 1), and includes a receiving unit 131, a transmitting unit 132, a displaying unit 133, an acquiring unit 134, and an activating unit 135.

Referring to FIGS. 1 and 13, in exemplary embodiments, the receiving unit 131 receives a copy instruction from a user for copying selected information through the information display interface of the first terminal 11. In response to the receiving unit 131 receiving the copy instruction, the transmitting unit 132 automatically transmits the information to a server, such as the cloud server 13, which operates as a clipboard. The displaying unit 133 displays a menu including an option of, e.g., “copy to cloud clipboard,” to the user when a specified operation executed by the user is detected. The option is used to receive the copy instruction from the user. In addition, the acquiring unit 134 acquires a sharing permission from the cloud server 13.

In one exemplary embodiment, the acquiring unit 134 sends a sharing request to the cloud server 13 and receives the sharing permission from the cloud server 13. After receiving the sharing request, the cloud server 13 assigns a specified location in its storage to an account used by the first terminal 11 when establishing a connection with the cloud server 13, and then sends the sharing permission to the first terminal 11. In another exemplary embodiment, the acquiring unit 134 does not send the sharing request. The cloud server 13 assigns a specified location in its storage to the account when the connection is established, and then sends the sharing permission to the acquiring unit 134.

The activating unit 135 activates the option in the menu after the acquiring unit 134 acquires the sharing permission. When the option is activated, the user can provide the copy instruction by selecting the option.

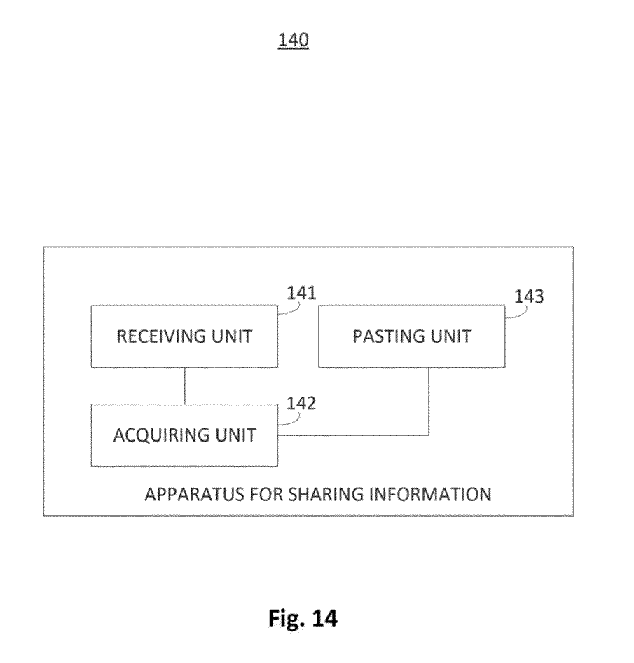

FIG. 14 illustrates a block diagram of an apparatus 140 for sharing information, according to an exemplary embodiment. The apparatus 140 is configured to operate in accordance with the above described methods for sharing information. Referring to FIG. 14, the apparatus 140 for sharing information is included in the second terminal 12 (FIG. 1), and includes a receiving unit 141, an acquiring unit 142, and a pasting unit 143.

Referring to FIGS. 1 and 14, in exemplary embodiments, the receiving unit 141 receives a paste instruction for pasting information copied at the first terminal 11 and stored in the cloud server 13, which operates as a clipboard. The acquiring unit 142 acquires information from the cloud server 13. The pasting unit 143 pastes the information in an information display interface of the second terminal 12.

In the illustrated exemplary embodiment of FIG. 14, the apparatus 140 for sharing information may further include a displaying unit (not shown). The displaying unit displays on the display 40 of the second terminal 12 a menu including an option of, e.g., “paste from cloud clipboard,” to the user when a specified operation executed by the user is detected. The option is used to receive the paste instruction from the user. In addition, the apparatus 140 for sharing information may further include a second receiving unit (not shown) and an additional displaying unit (not shown). The second receiving unit receives from the cloud server 13 a sharing reminder for reminding the information can be pasted. The additional displaying unit displays the sharing reminder to the user.

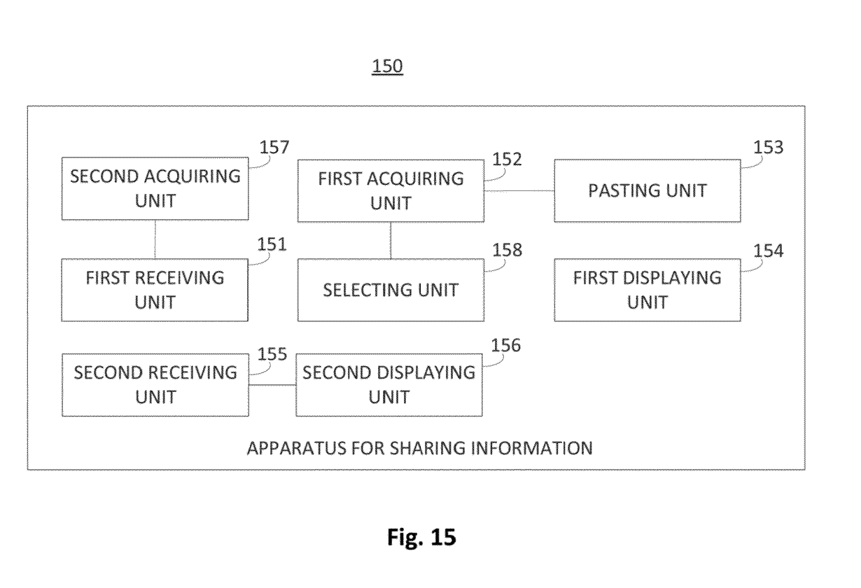

FIG. 15 is a block diagram of an apparatus 150 for sharing information, according to an exemplary embodiment. The apparatus 150 is configured to operate in accordance with the above described methods for sharing information. Referring to FIG. 15, the apparatus 150 for sharing information is included in the second terminal 12 (FIG. 1), and includes a first receiving unit 151, a first acquiring unit 152, a pasting unit 153, a first displaying unit 154, a second receiving unit 155, a second displaying unit 156, a second acquiring unit 157, and a selecting unit 158.

Referring to FIGS. 1 and 15, in exemplary embodiments, the first receiving unit 151 receives a paste instruction for pasting information copied at the first terminal 11 and stored in the cloud server 13, which operates as a clipboard. After the first receiving unit 151 receives the paste instruction, the second acquiring unit 157 acquires from the cloud server 13 a list of general descriptions of information stored in the cloud server 13. The selecting unit 158 then selects the information to be acquired based on the user's operation on the list. Further, the first acquiring unit 152 acquires the selected information from the cloud server 13, and the pasting unit 153 pastes the acquired information in the information display interface of the second terminal 12.

In addition, the first displaying unit 154 displays a menu including an option of, e.g., “paste from cloud clipboard,” to the user when a specified operation executed by the user is detected. The option is used to receive the paste instruction from the user. When the user selects the option, the first receiving unit 151 receives the paste instruction. Additionally, the second receiving unit 155 receives from the cloud server 13 a sharing reminder for reminding the information can be pasted, and the second displaying unit 156 displays the sharing reminder to the user.

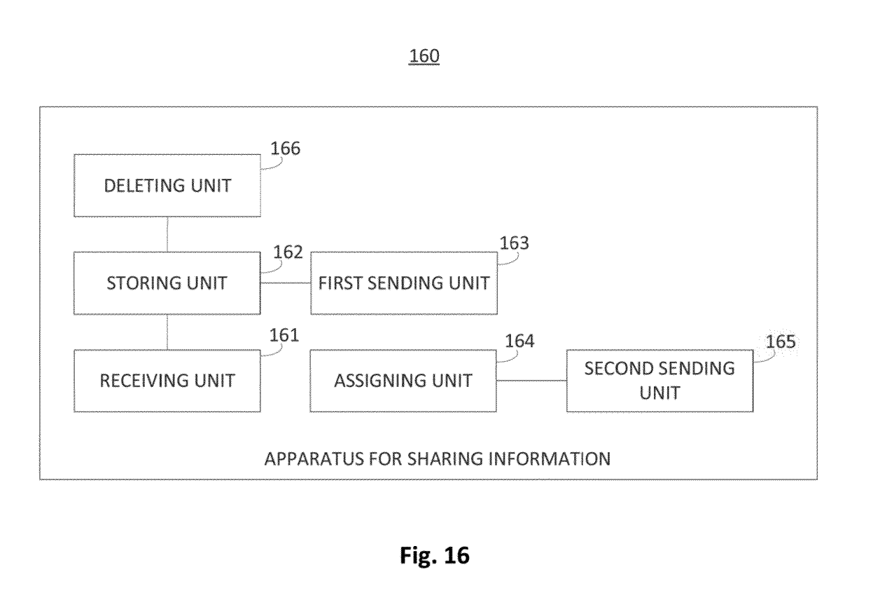

FIG. 16 is a block diagram of an apparatus 160 for sharing information, according to an exemplary embodiment. The apparatus 160 is configured to operate in accordance with the above described methods for sharing information. Referring to FIG. 16, the apparatus 160 for sharing information is included in the cloud server 13 (FIG. 1), and includes a receiving unit 161, a storing unit 162, and a first sending unit 163.

Referring to FIGS. 1 and 16, in exemplary embodiments, the receiving unit 161 receives information transmitted by the first terminal 11, and the storing unit 162 stores the information in the cloud server 13, which operates as a clipboard. The first sending unit 163 sends the information to the second terminal 12 when the second terminal 12 requests to acquire the information.

In exemplary embodiments, the apparatus 160 for sharing information may further include an assigning unit 164. The assigning unit 164 assigns a specified location in the storage of the cloud server 13 to store the information according to an account used by the first terminal 11 and the second terminal 12 when establishing a connection with the cloud server 13. Further, the apparatus 160 for sharing information may include a second sending unit 165. The second sending unit 165 sends a sharing permission when the specified location is assigned. In addition, the apparatus 160 for sharing information may include a deleting unit 166. The deleting unit 166 deletes the information from the cloud server 13 when a predetermined period of time is reached.

Program instructions to perform methods described herein, or one or more operations thereof, may be recorded, stored, or fixed in one or more computer-readable storage media. The program instructions may be executed by one or more processors. The media may include, alone or in combination with the program instructions, data files, data structures, and the like. Examples of computer-readable media include magnetic media, such as hard disks, floppy disks, and magnetic tape; optional media such as CD

ROM disks and DVDs; magneto-optical media, such as optical disks; and hard are devices that are specially configured to store and perform program instructions, such as read-only memory (ROM), random access memory (RAM), flash memory and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

The scope of the invention is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for sharing information for use in a first terminal, comprising:
receiving, through an information display interface of the first terminal, a copy instruction for copying selected information; and
transmitting, in response to the receiving of the copy instruction, the information to a server.

2. The method of claim 1, wherein receiving the copy instruction comprises:
detecting that a specified operation is executed by a user on the first terminal;
displaying, in response to the detecting, a menu including an option for copying the selected information; and
receiving the copy instruction when the option is selected by the user.

3. The method of claim 2, further comprising:
acquiring a sharing permission from the server; and
activating the option in the menu after acquiring the sharing permission.

4. A method for sharing information for use in a second terminal, comprising:
receiving a paste instruction for pasting information copied at a first terminal and stored in a server;
acquiring, in response to the receiving of the paste instruction, the information from the server; and
pasting the acquired information in an information display interface of the second terminal.

5. The method of claim 4, wherein receiving the paste instruction comprises:
detecting that a specified operation is executed by a user on the second terminal;
displaying, in response to the detecting, a menu including an option for pasting the information; and
receiving the paste instruction when the option is selected by the user

6. The method of claim 5, further comprising:
receiving from the server a sharing reminder for reminding the information can be pasted; and
displaying the received sharing reminder.

7. The method of claim 4, wherein acquiring the information comprises:
acquiring from the server a list of general descriptions of information stored in the server;
displaying the list; and
selecting the information to be acquired based on a user's operation on the list.

8. A method for sharing information for use in a server, comprising:
receiving information transmitted by a first e
storing the received information; and
sending the stored information to a second terminal in response to a request by the second terminal to acquire the information.

9. The method of claim 8, further comprising:
assigning a specified location in a storage of the server to store the received information according to an account used by the first terminal and the second terminal when establishing a connection with the server.

10. The method of claim 9, further comprising:
sending a sharing permission to the first terminal when the specified location is assigned.

11. The method of claim 8, further comprising:
deleting the stored information from the server when a predetermined period of time is reached.

12. The method of claim 8, further comprising:
sending a reminder to the second terminal after receiving the information transmitted by the first terminal.

13. An apparatus for sharing information and for use in a first terminal, comprising:
a receiving unit configured to receive, through an information display interface of the first terminal, a copy instruction for copying selected information; and
a transmitting unit configured to transmit, in response to the receiving unit receiving the copy instruction, the information to a server.

14. The apparatus of claim 13, further comprising:
a displaying unit configured to display a menu including an option for copying the selected information when a specified operation executed by a user is detected, wherein the receiving unit receives the copy instruction when the option is selected by the user.

15. The apparatus of claim 14, further comprising:
an acquiring unit configured to acquire a sharing permission from the server; and
an activating unit configured to activate the option in the menu after the acquiring unit acquires the sharing permission.

16. An apparatus for sharing information and for use in a second terminal, comprising:
a receiving unit configured to receive a paste instruction for pasting information copied at a first terminal and stored in a server;
an acquiring unit configured to acquire, in response to the first receiving unit receiving the paste instruction, the information from the server; and
a pasting unit configured to paste the information in an information display interface of the second terminal.

17. The apparatus of claim 16, further comprising:
a displaying unit configured to display a menu including an option for pasting the information when a specified operation executed by the user is detected, wherein the pasting unit pastes the information when the option is selected by the user.

18. The apparatus of claim 17, wherein the receiving unit is a first receiving unit and the displaying unit is a first displaying unit, the apparatus further comprising:
a second receiving unit configured to receive from the server a sharing reminder for reminding the information can be pasted; and
a second displaying unit configured to display the received sharing reminder.

19. The apparatus of claim 16, wherein the acquiring unit is a first acquiring unit, the apparatus further comprising:
a second acquiring unit configured to acquire from the server a list of general descriptions of information stored in the server;
a displaying unit to display the list; and
a selecting unit configured to select the information to be acquired based on a user's operation on the list.

20. An apparatus for sharing information and for use in a server, comprising:
a receiving unit configured to receive information transmitted by a first terminal;
a storing unit configured to store the received information by the server; and
a sending unit configured to send the stored information to a second terminal in response to a request by the second terminal to acquire the information.

21. The apparatus of claim 20, further comprising:
an assigning unit configured to assign a specified location in a storage of the server to store the information according to an account used by the first terminal and the second terminal when establishing a connection with the server.

22. The apparatus of claim 21, wherein the sending unit is a first sending unit, the apparatus further comprising:
a second sending unit configured to send a sharing permission to the first terminal when the specified location is assigned.

23. The apparatus of claim 20, further comprising:
a deleting unit configured to delete the stored information from the server when a predetermined period of time is reached.

24. The apparatus of claim 20, wherein the sending unit is a first sending unit, the apparatus further comprising:
a second sending unit configured to send a reminder to the second terminal after receiving the information transmitted by the first terminal.
